(19) United States
(12) Patent Application Publication
(10) Pub. No.: US 2019/0207402 A1
(43) Pub. Date: Jul. 4, 2019

(54) WEARABLE BATTERY CHARGING TECHNOLOGY FOR RECHARGEABLE HEARING AID BATTERIES

(71) Applicant: ZPOWER, LLC, Camarillo, CA (US)

(72) Inventors: Troy W. RENKEN, Alpharetta, GA (US); Ross E. DUEBER, Thousand Oaks, CA (US); Don BARRETT, Camarillo, CA (US)

(73) Assignee: ZPower, LLC, Camarillo, CA (US)

(21) Appl. No.: 16/303,241

(22) PCT Filed: May 25, 2017
(86) PCT No.: PCT/US2017/034392

§ 371 Date: Nov. 20, 2018

Related U.S. Application Data
(60) Provisional application No. 62/341,200, filed on May 25, 2016.

(51) Int. Cl. H02J 7/00; H04R 25/00

(52) U.S. Cl. CPC H02J 7/0054; H02J 7/0068; H04R 2225/31; H02J 7/0093; H04R 25/602; H02J 7/0086

(57) ABSTRACT

A method for charging a rechargeable battery of a body-worn electronic device includes obtaining, by charging circuitry of a charger, a voltage of the battery prior to charging the battery, the charging circuitry in electrical communication with a power source (e.g., an energy storage device) and the battery and comparing the battery voltage to a voltage threshold. When the battery voltage is less than the voltage threshold, the method also includes applying predetermined current pulses to the battery with power provided from the power source (e.g., energy storage device) to simultaneously charge the battery and power electrical components of the device. The method also includes setting a timer when the battery voltage reaches a predetermined voltage and ceases application of the current pulses to the battery when the timer indicates that a predetermined time has elapsed.

### CROSS REFERENCE TO RELATED APPLICATION

This PCT application claims the benefit of U.S. Provisional Application No. 62/341,200, filed on May 25, 2016. This document is incorporated herein by reference.

### TECHNICAL FIELD

This invention relates to methods and apparatuses for charging rechargeable batteries. Specifically, this invention relates to methods of charging a rechargeable battery that is powering a body worn device, wherein the rechargeable battery is charged while simultaneously powering the body worn device.

### BACKGROUND

Rechargeable batteries are known in the art and commonly used, for example, in portable electronic devices (e.g., hearing aids, headphones, and the like). Although conventional rechargeable batteries are useful, the systems and methods used to recharge the batteries are nevertheless susceptible to improvements that may enhance or improve their utility, portability, and/or performance. Therefore, a need exists in the art for the development of an improved apparatus for recharging batteries and a method for charging the same.

Traditional body worn devices powered by one or more rechargeable batteries typically require that the body worn device be inoperable while a battery charging device charges the rechargeable batteries. For instance, the charging device may require that the rechargeable batteries be removed from the body worn device for charging, placing the entire body worn device in the charger device for charging, or placing a portion of the body worn device in a charger device for charging. In any of these scenarios, the body worn device is inoperable until the charging session has at least partially recharged the rechargeable battery. Battery cells may be charged using a constant current-constant voltage with a maximum charge current and a maximum charge voltage. Devices that allow charging simultaneous with operation thereof require that most rechargeable battery chemistries be isolated from the load to charge the battery properly.

### SUMMARY OF THE INVENTION

The present invention provides a method for charging a rechargeable battery of a body-worn electronic device (e.g., a hearing aid, headphone, or earbud), the method comprises obtaining, by charging circuitry of a charger, a voltage of the battery (i.e., the rechargeable battery) prior to charging the battery, the charging circuitry in electrical communication with a power source (e.g., an energy storage device) and the battery; comparing, by the charging circuitry, the battery voltage to a voltage threshold; when the battery voltage is less than the voltage threshold:

applying, by the charging circuitry, predetermined current pulses to the battery with power provided from the power source (e.g., an energy storage device (e.g., a primary alkaline battery, rechargeable battery, or other energy storage device) to simultaneously charge the battery and power electrical components of the device;

setting, by the charging circuitry, a timer when the battery voltage reaches a predetermined voltage; and

ceasing, by the charging circuitry, application of the current pulses to the battery when the timer indicates that a predetermined time has elapsed.

In some implementations, the predetermined current pulses have an amplitude comprising a sum of a battery charge current portion to charge the battery and an additional load current portion to compensate for a load upon the battery for powering the electrical components of the device.

In some implementations, the battery charge current portion is greater than the additional load current portion.

In some implementations, a duration of the current pulses is longer than an off time between the current pulses. For instance, the duration of the current pulses is 1.5 s and the off time between current pulses is between 0.01 s and 1.0 s, the duration of the current pulses is 1.5 s and the off time between current pulses is between 0.4 s and 0.6 s, the duration of the current pulses is 1.0 s and the off time between current pulses is between 0.01 s and 0.9 s, or the duration of the current pulses is 0.75 s and the off time between current pulses is between 0.01 s and 0.5 s.

In some implementations, a duration of the current pulses avoids detection by a charge sense circuit implemented by the device.

In some implementations, the power source comprises an energy storage device housed by the charger and in electrical communication with the battery when the charging circuitry is electrically connected to the battery. Energy storage devices include any primary battery, any secondary battery, or any combination thereof that is suited to be housed in a charger that can be worn on the body.

In some implementations, the body-worn electronic device comprises a hearing aid device (e.g., a behind the ear hearing aid or an in the ear hearing aid). In other implementations, the body-worn electronic device comprises an ear bud or headphones.

In some implementations, the battery comprises a rechargeable silver-zinc battery.

In some implementations, the battery comprises a single cell or two or more cells in series, and wherein the charging circuitry is implemented upon a silicon chip.

In some implementations, the predetermined voltage corresponds to one of a peak polarization voltage or a predetermined voltage value near the peak polarization voltage (e.g., from about 1.90 V to about 2.50 V, from about 1.95 V to about 2.25 V, or from about 1.95 V to about 2.00 V).

In some implementations, the charging circuitry of the charger implements a microcontroller.

Another aspect of the present invention provides a wearable charging system comprising a first device (e.g., a hearing aid, ear bud, or headphones) housing a rechargeable battery configured to provide power to electrical components of the first device; an energy storage device (e.g., a primary, i.e., non-rechargeable, battery, a secondary, i.e., rechargeable, battery, or any combination thereof); and a charger comprising charging circuitry configured to provide electrical communication between the energy storage device and the rechargeable battery when the charging circuitry is electrically connected to the rechargeable battery, the charging circuitry:
obtaining a voltage of the rechargeable battery prior to charging the rechargeable battery when the charging circuitry is electrically connected to the rechargeable battery;
comparing the rechargeable battery voltage to a voltage threshold;
when the rechargeable battery voltage is less than the voltage threshold, applying predetermined current pulses to the rechargeable battery with power provided from the energy storage device to simultaneously charge the rechargeable battery and power the electrical components of the first device;
starting a timer when the rechargeable battery voltage reaches a predetermined voltage greater than the voltage threshold; and
ceasing application of the predetermined current pulses to the rechargeable battery when the timer indicates that a predetermined time period has elapsed.

In some embodiments, the charger houses the energy storage device (e.g., a primary, i.e., non-rechargeable, battery, a secondary, i.e., rechargeable, battery, or any combination thereof) and is configured to attach to a user of the device. Examples of energy storage devices include primary alkaline batteries and other rechargeable batteries that do not directly charge the first device, but power current pulses to the rechargeable battery that powers the first device.

Some embodiment further comprise:

a charging terminal configured to electrically connect with one or more charging elements of the first device, the charging elements in electrical communication with the rechargeable battery; and

one or more wires providing electrical communication between the charging circuitry and the charging terminal, the charging circuitry electrically connects to the rechargeable battery when the charging terminal is electrically connected with the one or more charging elements.

In some implementations, the predetermined current pulses have an amplitude comprising a sum of a battery charge current portion to charge the rechargeable battery and an additional load current portion to compensate for a load upon the rechargeable battery for powering the electrical components of the first device.

In some implementations, the battery charge current portion is greater than the additional load current portion.

In some implementations, a duration of the current pulses is longer than an off time between the current pulses. For instance, the duration of the current pulses is 1.5 s and the off time between current pulses is between 0.01 s and 1.0 s, the duration of the current pulses is 1.5 s and the off time between current pulses is between 0.4 s and 0.6 s, the duration of the current pulses is 1.0 s and the off time between current pulses is between 0.01 s and 0.9 s, or the duration of the current pulses is 0.75 s and the off time between current pulses is between 0.01 s and 0.5 s.

In some implementations, a duration of the current pulses avoids detection by a charge sense circuit implemented by the first device. For instance, the duration of the current pulses is too brief to be detected by a charge sense circuit implemented by the first device.

In some implementations, the first device comprises a hearing aid device (e.g., a behind the ear hearing aid or an in the ear hearing aid) worn by a user. In other implementations, the first device comprises headphones or an ear bud.

In some implementations, the charging circuitry implements a microcontroller or is implemented upon a silicon chip.

### BRIEF DESCRIPTION OF DRAWINGS

The following figures are provided by way of example and are not intended to limit the scope of the invention.

FIG. 1A is a schematic view of an example environment for an example wearable charging system.

FIG. 1B is a schematic view of an example wearable charging system.

FIG. 2 is a schematic view of example charging circuitry for an example charging device.

FIG. 3 is a schematic view of a voltage circuit of a battery-powered body worn device.

FIG. 4 shows an example plot of a discharge voltage over time for a rechargeable silver-zinc battery.

FIG. 5 shows an example plot providing a battery voltage, charging voltage, and current pulses over time when simultaneously charging a silver-zinc battery of a body worn device and powering electrical components of the body worn device.

FIG. 6 provides a flowchart for a method of charging a battery according to implementations of the present invention.

Like reference symbols in the various drawings indicate like elements.

### DETAILED DESCRIPTION

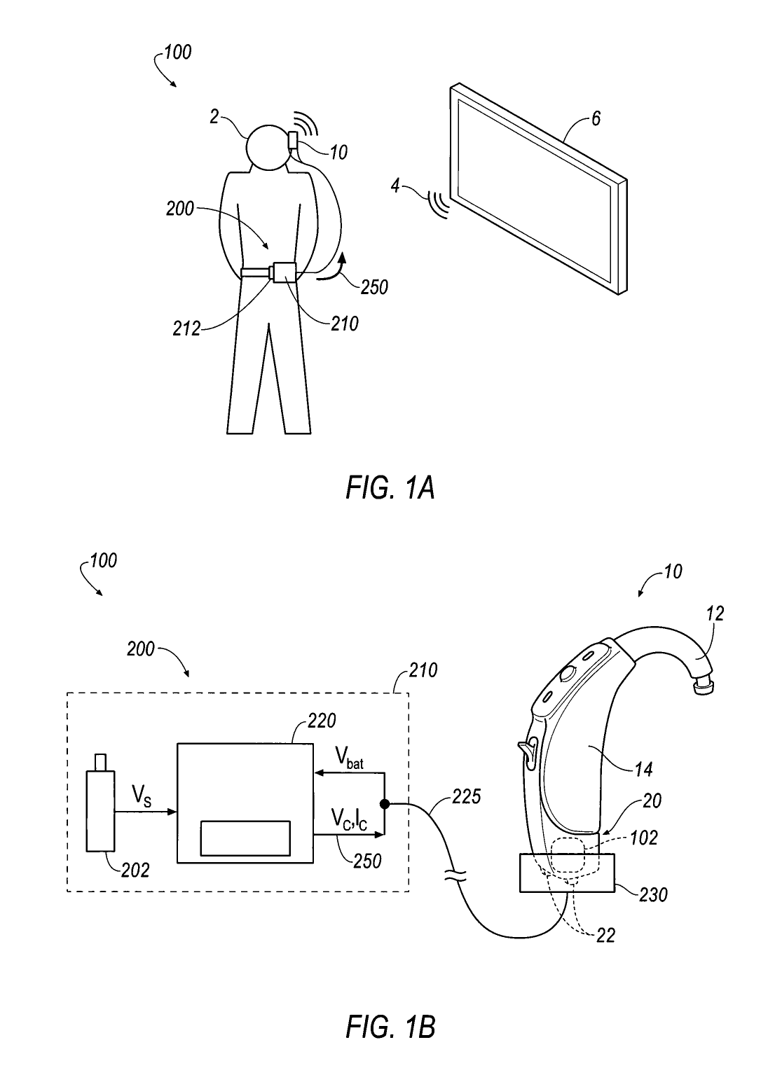

In some implementations, referring to FIGS. 1A and 1B, an example wearable charging system 100 includes a charging device 200 (e.g., charger) that charges a rechargeable battery 102 configured to power electrical components of a body worn device 10. For example, the rechargeable battery 102 may power a hearing aid device 10, such as a behind the ear hearing aid or an in the ear hearing aid. In other examples, the rechargeable battery 102 may power an ear bud or headphones. In some examples, the rechargeable battery 102 is operable to dock with the charging device 200 while housed within the hearing aid device 10 so that the charging device 200 can implement a charging session that applies predetermined current pulses 250 to simultaneously charge the rechargeable battery 102 and power the electrical components of the hearing aid device 10. Traditional charging systems for charging a rechargeable battery of a body worn device conversely require that the rechargeable battery be removed from the device and docked with the charger or require the body worn device be removed from the user and docked with the charger to execute the charging session. In either scenario, the functionality of the body worn device is inoperable while the charger is charging the rechargeable battery.

FIG. 1A shows a user 2 wearing the hearing aid device 10 and continuing to operate the device 10 to amplify sounds 4 from a source 6 while simultaneously charging the rechargeable battery 102 when the rechargeable battery 102 docks with the charging device 200. For instance, the user 2 may wear hearing aid devices 10 proximate to each ear and the hearing aid devices 10 may be configured for wireless streaming functionality to amplify sounds 4 from a multimedia source 6 such as a television, portable music player (e.g., an mp3 player or the like), set-top box, DVD player, Blu-ray player, HD media player, or other multimedia component, or any combination thereof. The use of the wireless streaming functionality by hearing aid devices 10 consequently causes an increased current drain on the rechargeable battery 102, thereby increasing the number of charging sessions required to keep the rechargeable battery 102 at a suitable charge capacity (e.g., greater than 50%) while maintaining full operation of the hearing aid device 10.

FIG. 1B shows the hearing aid device 10 having an earpiece 12, a shell portion 14, and a battery door module (BDM) 20 attached to the shell portion 14. The shell portion 14 may enclose electrical components such as, but not limited to, a microphone, a signal processor, an audio amplifier, related electrical circuitry, and a loud speaker or other audio output device. The BDM 20 receives the rechargeable battery 102 for powering the electrical components within the shell portion 14 and includes charging elements 22 to provide recharging capabilities of the rechargeable battery 102 without having to remove the BDM 20 from the shell portion 14 and/or remove the rechargeable battery 102 from the BDM 20. Described in greater detail below, charging elements 22 enable the rechargeable battery 102 of the hearing aid device 10 to electrically connect with the charging circuitry 220 of the charging device 200 to charge the rechargeable battery 102 without having to remove the BDM 20 from the shell portion 14. In some examples, the charging elements 22 include charging pins; while, in other examples, the charging elements 22 include charging pads. In some implementations, the charging elements 22 are at opposite ends to conform to sizing constrains when the rechargeable battery 102 is indicative of a 312 size button cell. In the example shown, the charging elements 22 include pins having tips exposed from the BDM 20. In other examples, the charging elements 22 include pins or pads entirely recessed within the BDM 20.

In some configurations, the rechargeable battery 102 includes two or more batteries electrically connected in series with the charging circuitry 120 to undergo a charging session. Accordingly, the use of the term “battery 102” herein may refer to a single battery or multiple batteries connected in series. In some implementations, the rechargeable battery is a silver-zinc (AgZn) battery; however, the battery may include a lithium ion battery, a nickel metal hydride battery, a rechargeable zinc-air battery, or other rechargeable battery. Implementations herein will refer to the rechargeable battery 102 as an AgZn battery type.

With continued reference to FIGS. 1A and 1B, the rechargeable battery 102 docks or electrically connects to the charging circuitry 220 of the charging device 200 when a charging terminal 230 electrically connects with the charging elements 22 of the hearing aid device 10. Here, one or more wires 225 provide electrical communication between the charging circuitry 220 and the charging terminal such that the charging circuitry 220 electrically connects to the rechargeable battery 102 when the charging terminal 230 is electrically connected with the charging elements 22 of the hearing aid device 10 and in electrical communication with the rechargeable battery 102 enclosed therein. In some examples, the BDM 20 and the charging terminal 230 include corresponding magnetic elements to attach the charging terminal 230 to the BDM 20 and thereby electrically connect the rechargeable battery 102 to the charging circuitry 220 of the charging device 200.

The charging device 200 includes a housing 210 enclosing an energy storage device 202 (such as any of the energy storage devices described herein) and charging circuitry 220 in electrical communication with the energy storage device 202, whereby the charging circuitry 220 receives a supply voltage V_{S} from the energy storage device 202 to provide the predetermined current pulses 250 to simultaneously charge the rechargeable battery 102 (or batteries) and power the electrical components of the body worn device 10 (e.g., hearing aid device, ear bud, or headphones) when the rechargeable battery 102 is electrically connected with the charging circuitry 220, e.g., when the BDM 20 docks with the charging device 200 by attaching the charging terminal 230 to the BDM 20 and using the wires 225 to provide electrical communication between the terminal 230 and the charging circuitry 220. In some examples, the energy storage device 202 includes a primary alkaline battery (e.g., 9V). In some examples, the charging device 200 is configured to attach to the user 2 of the body-worn device 10. For instance, the housing 210 may include one or more attachment features 212 (e.g., clips, straps, snaps, buttons, hook and loop fasteners, any combination there, and the like) configured to attach to the user 2 or an article of clothing worn by the user 2. The housing 210 may only be large enough to house the energy storage device 202 and the charging circuitry 220 such that the charging device 200 does not hinder movement by the user 2 while attached thereto.

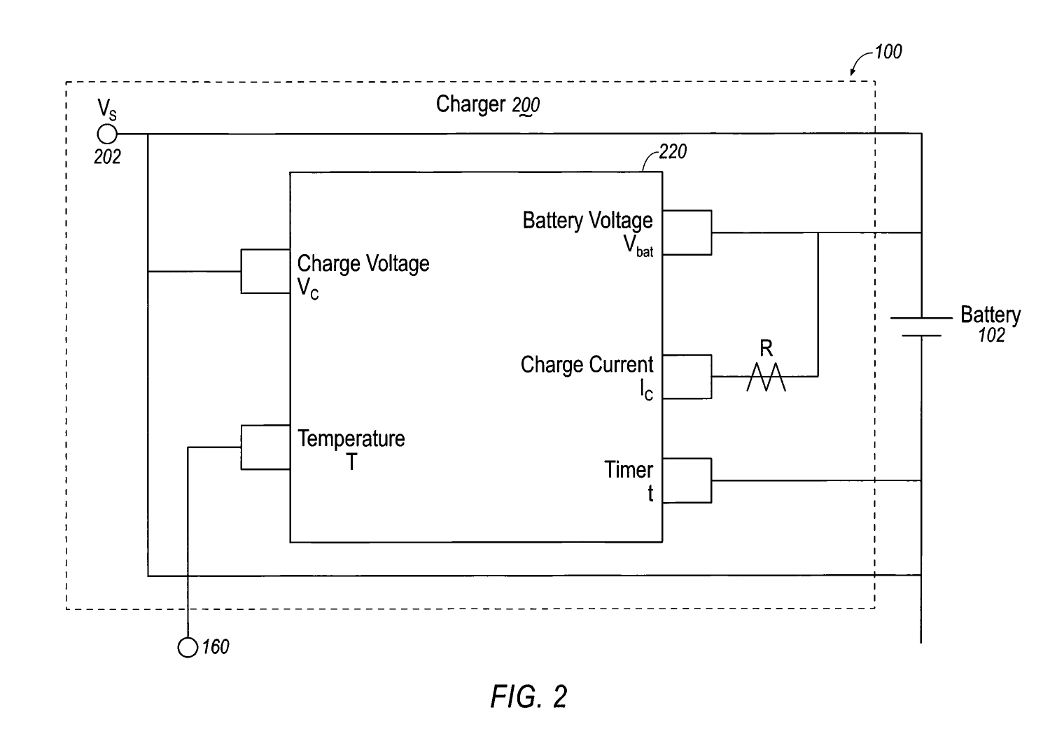

Referring to FIG. 2, a schematic view of the charging circuitry 220 of the charging device 200 of the wearable charging system 100 of FIGS. 1A and 1B is shown. In some implementations, the charging circuitry 220 implements a microcontroller to control charging parameters to charge the rechargeable battery 102. In other implementations, a chip implements the charging circuitry 220 to control the charging parameters to charge the rechargeable battery 102. For example, silicon chips may implement the charging circuitry 220 to reduce a size and manufacturing costs of the charging device 200 since a microprocessor and/or integrator are omitted from the charging device 100.

The charging circuitry 220 uses timer data (e.g., timer (t)) in combination with a discharge voltage over time of the battery 102 to determine when to initiate, as well as when to end, a charging session to charge the rechargeable battery 102 while permitting the hearing aid device 10 to operate during the charging session. The charging circuitry 220 may additionally use temperature data (e.g., ambient temperature (T)). The charging circuitry 220 senses or obtains charging voltage (V_{C}) and charge current (I_{C}) received from the energy storage device 202 in any suitable manner. For example, one or more resistors R may be used for obtaining charge current flow.

The charging circuitry 220 initiates the charging session when a voltage (V_{bat}) of the rechargeable battery 102 is less than a voltage threshold (e.g., from about 1.65 V to about 1.75 V, or about 1.7 V) by applying the predetermined current pulses 250 to the battery 102 with power (e.g., V_{S}) provided from the energy storage device 202. The predetermined current pulses 250 provide sufficient power to the rechargeable battery 102 for charging the rechargeable battery 102 as well to compensate for a load upon the rechargeable battery 102 for powering the electrical components of the hearing aid device 10 during the charging session. That is to say, the predetermined current pulses 250 are associated with the charge current I_{C} based on a sum of a battery charge current needed to charge the battery 102 and an additional load current needed to compensate for loads upon the hearing aid device 10 during use thereof. The timer t may increment from zero when the V_{bat} reaches a predetermined voltage during the charging session, and when the value of the timer t indicates a predetermined period of time has elapsed, the charging circuitry 220 may cease application of the predetermined current pulses 250 to the rechargeable battery 102. The predetermined voltage may correspond to a peak polarization voltage (V_{PP}) or a predetermined voltage near the V_{PP}. In some examples, the V_{PP} is from about 1.90 V to about 2.50 V, from about 1.95 V to about 2.25 V, or from about 1.95 V to about 2.00 V. Accordingly, the charging circuitry 220 may continue applying the current pulses 250 for an additional fixed capacity (mAh) after the V_{bat} reaches the predetermined voltage. The charging circuitry 220 continuous to monitor the V_{bat} when the charging session terminates and subsequently initiates the charging session again when the V_{bat} falls below the voltage threshold. Thus, the wearable charging system 100 may maintain the rechargeable battery at a charge capacity greater than 50% while allowing full operation of the hearing aid device 10.

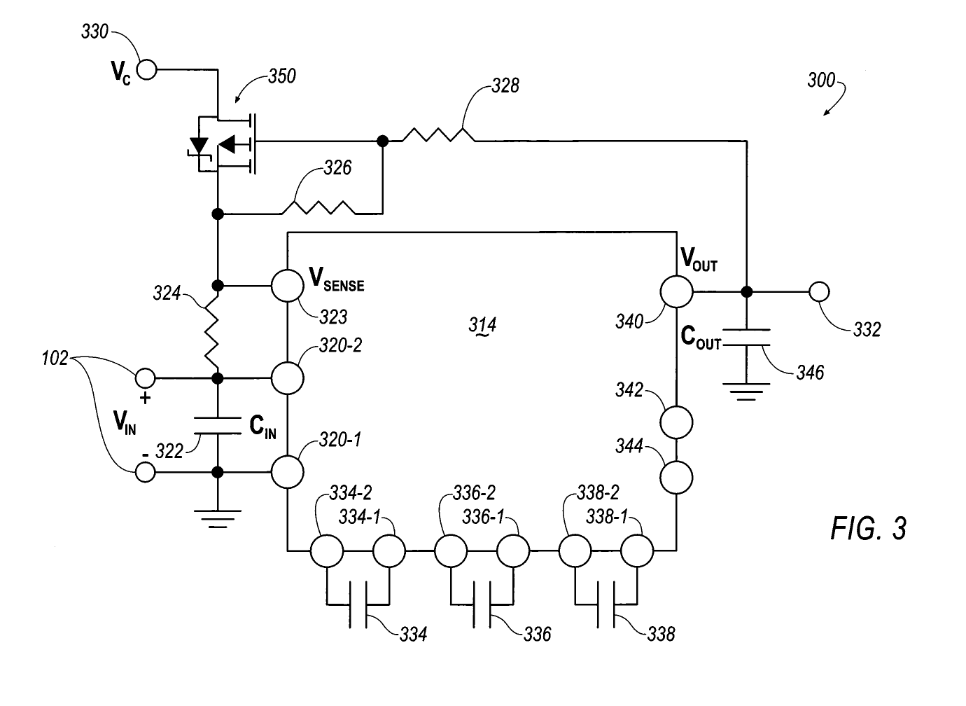

Referring to FIG. 3, a schematic view of a voltage circuit 300 implemented by the hearing aid device 10 (e.g., enclosed by the BDM 20) is illustrated. The voltage circuit 300 may be provided by a voltage regulator 314 implemented with an application specific integrated circuit (ASIC) upon a printed circuit board assembly (PCBA) enclosed within the BDM 20 of the hearing aid device 10. The voltage circuit 300 includes the battery 102, an input capacitor C_{IN} 322, current sense resistor R_{C} 324, bias resistors R_{B1} 326 and R_{B2} 328, a switch device 350, a charging terminal 330, a hearing aid terminal 332, and an output capacitor C_{OUT} 346. In a non-limiting example, the C_{IN} 322 and the C_{OUT} 346 are both equal to 1.0 μF, the R_{C} 324 is equal to 49.9 SI, and the battery resistors R_{B1} 326 and R_{B2} 328 are equal to 499 kΩ and 1.0 MΩ, respectively.

The rechargeable battery 102 supplies an input voltage (V_{IN}) via negative (BAT−) and positive (BAT+) terminals to corresponding terminals 320-1 and 320-2 of the voltage regulator 314. In the illustrated example, the negative and positive terminals 320-1 and 320-2 can collectively be referred to as an “input terminal” of the voltage regulator 314. Based upon the magnitude of the VIN supplied from the rechargeable battery 102, the voltage regulator 316 provides the V_{OUT} via output terminal 340 for powering the hearing aid terminal 332 electrically connected to one or more of the electrical components of the hearing aid device 10.

The voltage circuit 300 of FIG. 3 may include one or more flying capacitors. In the example shown, the voltage circuit 300 includes first, second and third flying capacitors C₁ 334, C₂ 336 and C₃ 338, respectively. Each of the flying capacitors is identical, and in a non-limiting example, includes a capacitance of 470 nF. Negative terminals of the flying capacitors are electrically connected to corresponding terminals 334-1, 336-1 and 338-1 of the voltage regulator 316. Positive terminals of the flying capacitors are electrically connected to corresponding terminals 334-2, 336-2 and 338-2 of the voltage regulator 316. The voltage regulator 316 further includes EOL voltage terminals 342 and 344 to configure EOL voltages necessary for configuring how the voltage regulator 316 implemented with the ASIC will signal a low battery warning at the hearing aid terminal 332.

Still referring to FIG. 3, when the user does not require use of the hearing aid device 10, such as when the user 2 is going to sleep, the charging terminal 330 may selectively electrically connect to an external charging base for charging the rechargeable battery 102 using constant charge-constant voltage (CC-CV) to charge the rechargeable battery 102 to a full charge. Accordingly, to indicate that the voltage circuit 300 is electrically connected to the external charging base and the battery is undergoing the charging event, the voltage regulator 316 includes a sensing terminal 325 for sensing a charging current (V_{SENSE}) between the b rechargeable battery 102 and the charging base via the charging elements 22 of the terminal 330. Specifically, the charging current (V_{SENSE}) is sensed by detecting voltage across the current sense resistor R_{C} 324. The hearing aid device must be shut down (e.g., off mode or stand-by mode) to avoid draining the battery 102 during the charging event and to prevent feedback noise or whistling from occurring during charging. Thus, the voltage regulator 316 may detect the presence of a charge current via the sensing terminal 325 and reduce the V_{OUT} to zero to shut down the hearing aid device during the charging event. By isolating the load from the rechargeable battery 102 the charging base is able to measure charge current to the battery 102 accurately for achieving a full charge for the rechargeable battery 102 during the overnight charging session by the charging base.

Conversely to the aforementioned overnight charging scenario that shuts down the hearing aid device 10 to fully charge the rechargeable battery 102, the user 2 may use the wearable charging device 200 to simultaneously charge the rechargeable battery 102 and power the electrical components of the device 10 by applying the predetermined current pulses 250 to the rechargeable battery 102. By contrast to charging the rechargeable battery 102 using CC-CV, the predetermined current pulses 250 prevent the sensing terminal 325 from sensing any charging current (V_{SENSE}) between the rechargeable battery 102 and the wearable charging device 200 via the charging elements 22 of the terminal 330. In some examples, the predetermined current pulses 250 include an ON duration that is longer than an OFF duration separating each pulse. For instance, the current pulses 250 may include 1.5 second ON durations and 0.5 second OFF durations. Here, the current pulses 250 are sufficient to charge the rechargeable battery 102 but not long enough to be detected by the sensing terminal 325 such that the device 10 is shut down by reducing V_{OUT} to zero. Accordingly, the predetermined current pulses 250 allow the hearing aid device 10 to be fully operational during charging of the rechargeable battery 102 (or batteries).

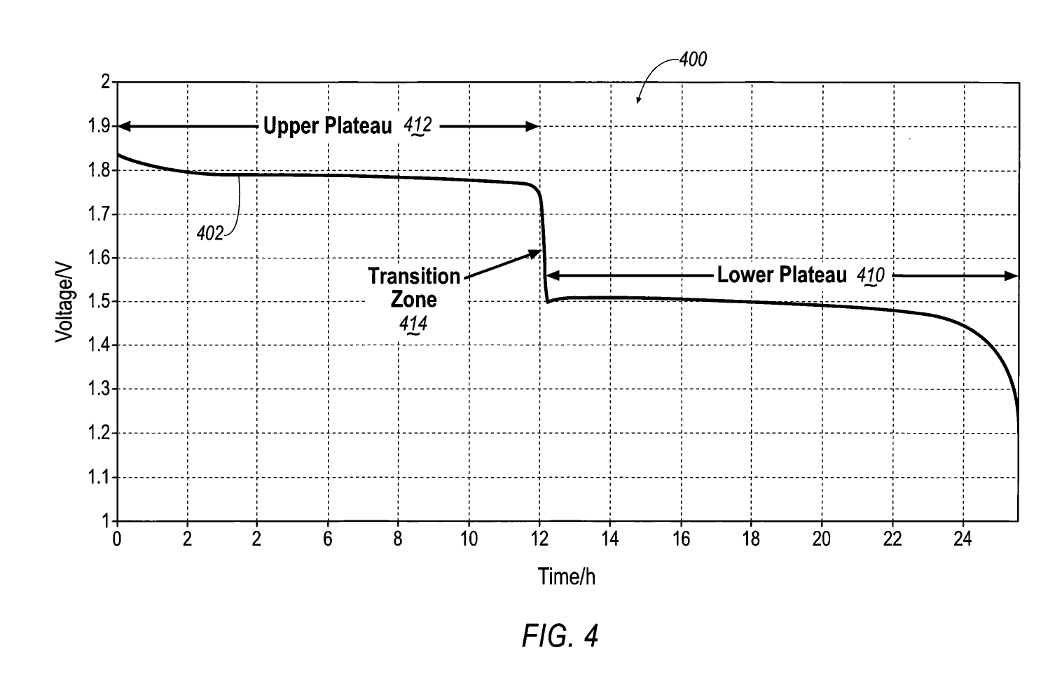

In some examples, the rechargeable AgZn battery 102 includes a maximum voltage (V_{bat}_{_}ₘₐₓ) equal to about 1.86 V (i.e., 1.7 V to 1.8 V under load). Thus, two AgZn batteries 102 in series includes a V_{bat}_{_}ₘₐₓ equal to about 3.72 V (i.e., 3.4 V to 3.6 V under load). FIG. 4 shows an example plot 400 of a discharge voltage 402 over time for the rechargeable AgZn battery 102. The horizontal x-axis denotes time in hours (h) and the vertical y-axis denotes voltage (V). The discharge voltage 402 shows the rechargeable AgZn battery 102 may discharge in a first zone 410 corresponding to a lower voltage plateau or may discharge in a second zone 412 corresponding to an upper voltage plateau, depending on the state of charge or open circuit voltage of the battery when charging starts. A transition zone 414 corresponds to region between the first and second zones 410, 412, respectively. Accordingly, from a full charge with an open circuit voltage (OCV) of about 1.86 V, the discharge voltage 402 shows the rechargeable AgZn battery 102 discharging in the second zone 412 for about 12 hours until falling to about 1.5 V and discharging in the first zone 410 from about 12 hours to about 24 hours before depleting.

In some implementations, the wearable charging device 200 executes the charging session to charge the rechargeable battery 102 by applying the predetermined current pulses 250 when the battery 102 is discharging in, or about to discharge in, the first zone 410 corresponding to the lower voltage plateau. For instance, the wearable charging device 200 may commence application of the predetermined current pulses 250 when the V_{bat} is less than the voltage threshold. In some examples, the voltage threshold is 1.7 V (e.g., 1.7 V/cell), where values less than 1.7 V correspond to the battery 102 discharging in the first zone 410, and thereby requiring charging from the predetermined current pulses 250. As set forth above, the predetermined current pulses 250 provide a charging current I_{c} that includes a sum of a battery charge current portion to charge the rechargeable battery 102 and an additional load current portion to compensate for the load upon the rechargeable battery 102 for powering the electrical components of the hearing aid device 10. The battery charge current portion may be greater than the additional load current portion such that the rechargeable battery 102 charges instead of depleting. Once the V_{bat} is charged to a value that reaches the predetermined voltage (e.g., V_{PP}), the charging device 200 continues to charge the rechargeable battery 102 using the predetermined current pulses 250 for a fixed capacity. The fixed capacity may correlate to continued application of the current pulses 250 for a predetermined time from when the V_{bat} reaches the predetermined voltage (e.g., V_{PP}). Accordingly, the timer t may increment from zero upon V_{bat} reaching the predetermined voltage and the charging circuitry 220 may cease application of the predetermined current pulses when the value of the timer t indicates that the predetermined time has elapsed.

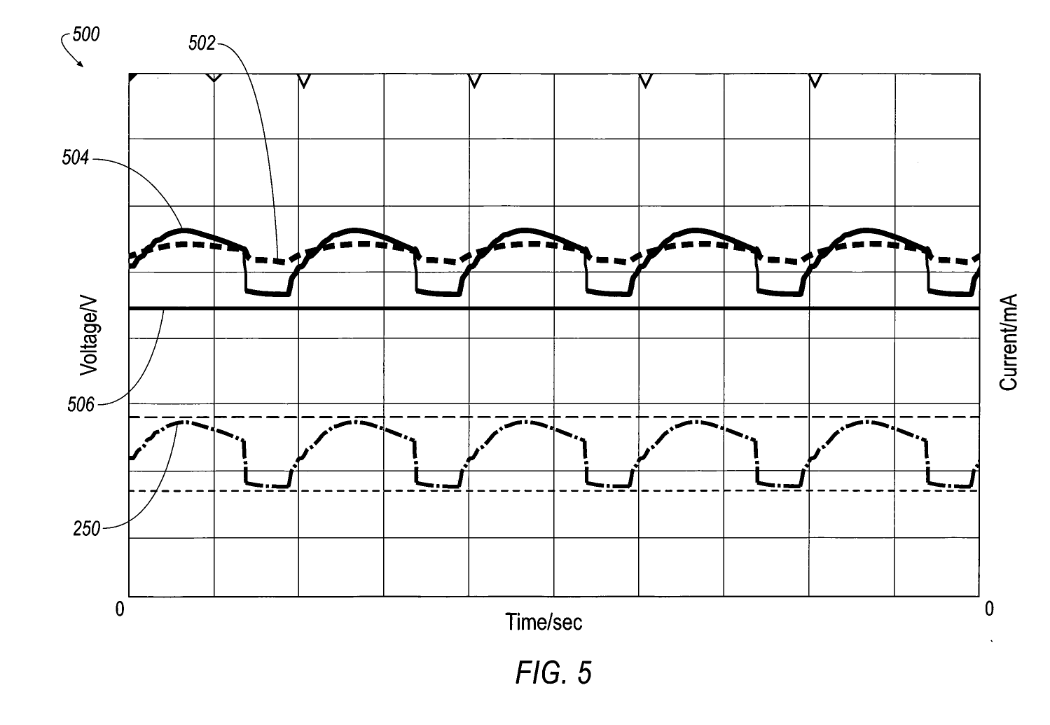

FIG. 5 shows an example plot 500 providing a battery voltage (V_{bat}) 502 (e.g., V_{bat} per cell when two cells are in series), charging voltage (V_{C}) 504, V_{OUT} 504, and current pulses 250 over time when the wearable charging device 200 applies the current pulses 250 to simultaneously charge the rechargeable silver-zinc battery 102 and power the electrical components of the hearing aid device 10. As the V_{OUT} 504 is greater than zero, the hearing aid device 10 is fully operational while the rechargeable battery 102 is undergoing the charging session. The horizontal x-axis denotes time (sec), the left-side vertical y-axis denotes voltage (V) and the right-side vertical y-axis denotes current (mA).

The plot 500 shows the V_{C} 504 and associated current pulses 250 having an ON duration longer than an OFF duration between each of the pulses. For instance, the ON duration is equal to about 1.5 sec while the OFF duration is equal to about 0.5 sec. The V_{bat} 502 increases as the battery 102 charges during the ON duration of each current pulse 250 and decreases as the battery 102 discharges during the OFF duration between the pulses 250 since the rechargeable battery 102 is providing the load current to power the electrical components of the device 10. The amplitude of each current pulse 250 includes a sum of a battery charge current portion to charge the rechargeable battery 102 and an additional load current portion to compensate for the additional load associated with powering the electrical components of the hearing aid device 10.

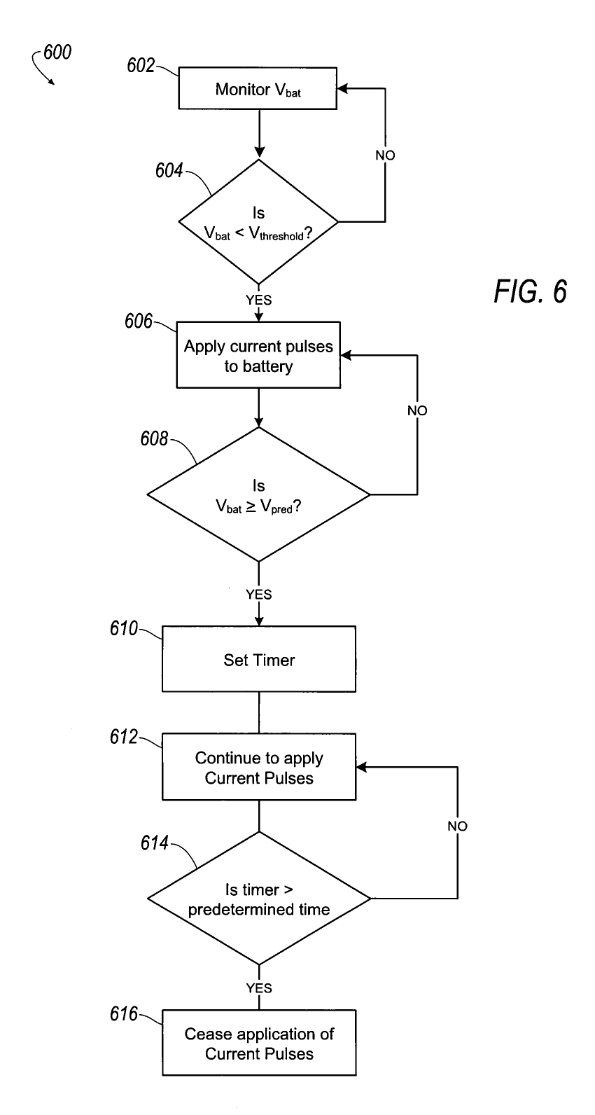

FIG. 6 provides a flowchart 600 for a method of simultaneously charging a rechargeable battery 102 of a body-worn device 10 and powering the body-worn device 10. The method provided by the flow chart 600 equally applies to the charging of two or more rechargeable batteries 102 in series. At block 602, the charging circuitry 220 obtains the voltage (V_{bat}) for the rechargeable battery 102 prior to charging the rechargeable battery 102, and at decision block 604, the charging circuitry 220 compares the V_{bat} to the voltage threshold to determine whether or not the V_{bat} is less than the voltage threshold. In some examples, the voltage threshold is 1.7 V (e.g., 1.7 V/cell), where values less than 1.7 V correspond to the rechargeable battery 102 discharging in the first zone 410 (e.g. lower voltage plateau) of the plot 400 of FIG. 4. The energy storage device 202 and the charging circuitry 220 may be housed together in the housing 210 of the charger device 200. Optionally, the energy storage device 202 may be external to the housing 210 of the charger device 200 and may electrically connect to the charging circuitry 220 via a wire or wirelessly via inductance. In some optional configurations, the energy storage device 202 is associated with an external power outlet electrically connected to the charging circuitry 220. If the V_{bat} is not less than the voltage threshold, i.e., decision block 604 is “NO”, then the charging circuitry 220 continues to obtain the V_{bat} at block 602 until the V_{bat} is less than the voltage threshold.

On the other hand, if the V_{bat} is less than the voltage threshold, i.e., decision block 604 is “YES”, then the charging circuitry 220 proceeds to block 606 and applies the predetermined current pulses 250 to the rechargeable battery 102 with power provided from the energy storage device 202 to simultaneously charge the rechargeable battery 102 and power the electrical components of the body-worn device 10. In some examples the energy storage device 202 is an alkaline 9V battery and the body-worn device 10 is a hearing aid device worn by a user for amplifying noise. In some examples, an amplitude of the predetermined current pulses 250 is equal to a sum of a battery charge current portion to charge the rechargeable battery 102 and an additional load current portion to compensate for a load upon the rechargeable battery 102 for powering the electrical components of the device. The battery charge current portion of the current pulses 250 may be greater than the additional load current portion of the current pulses 250 such that the battery charges while operating the device 10. In some examples, a duration of the current pulses 250 is longer than an off time between the current pulses 250. However, the ON duration of each current pulse 250 is sufficient for charging the battery but short enough to avoid detection by the charge sense terminal 323 of the voltage circuit 300 of FIG. 3 of the body-worn device 10.

At decision block 608, the charging circuitry 220 determines if the V_{bat} is greater than or equal to a predetermined voltage while applying the predetermined current pulses. The predetermined voltage may correspond to one of a peak polarization voltage (V_{PP}) or a predetermined voltage value near the peak polarization voltage (V_{PP}). The charging circuitry 220 sets the timer t at block 610 when the V_{bat} reaches the predetermined voltage, and at block 612, continues to apply the predetermined current pulses 250 to the battery 102 for a fixed capacity. This fixed capacity is generally not enough to fully charge the rechargeable battery 102, but is sufficient to charge the rechargeable battery 102 deep into the second zone 412 (e.g. upper voltage plateau) of the plot 400 of FIG. 4.

At decision block 614, the charging circuitry 220 determines if a value of the timer is greater than a predetermined time such that the fixed capacity is reached. If the charging circuitry 220 determines the timer does not indicate that the predetermined time has elapsed, i.e., decision block 614 is a “NO”, then the charging circuitry 220 reverts back to block 612 and continues to apply the predetermined current pulses 250 to the rechargeable battery 102. On the other hand, if the charging circuitry 220 determines the timer indicates that the predetermined time has elapsed, i.e., decision block 614 is “YES”, then the charging circuitry 220 proceeds to block 616 and ceases application of the current pulses to the rechargeable battery 102 to end charging of the rechargeable battery 102.

When the charging ends at block 616, the method may revert back to block 602 and continue to monitor the V_{bat} until the V_{bat} falls below the voltage threshold at decision block 604. Thereafter, the charging circuitry 220 repeats the same charging method. Accordingly, the exemplary charging method keeps the rechargeable battery 102 at a charge capacity greater than 50% while maintaining full operation of the body worn device 10 (e.g., the hearing aid device).

Implementations have been described. Nevertheless, it will be understood that various modifications may be made without departing from the spirit and scope of the disclosure. Accordingly, other implementations are within the scope of the following claims.

What is claimed is:

1. A method for charging a rechargeable battery of a body-worn electronic device, the method comprising:
obtaining, by charging circuitry of a charger, a voltage of the rechargeable battery prior to charging the rechargeable battery, the charging circuitry in electrical communication with a power source and the rechargeable battery;
comparing, by the charging circuitry, the battery voltage to a voltage threshold;
when the battery voltage is less than the voltage threshold:
applying, by the charging circuitry, predetermined current pulses to the rechargeable battery with power provided from the power source to simultaneously charge the rechargeable battery and power electrical components of the device;
setting, by the charging circuitry, a timer when the battery voltage reaches a predetermined voltage;
ceasing, by the charging circuitry, application of the current pulses to the rechargeable battery when the timer indicates that a predetermined time has elapsed.

2. The method of claim 1, wherein the predetermined current pulses have an amplitude comprising a sum of a battery charge current portion to charge the battery and an additional load current portion to compensate for a load upon the rechargeable battery for powering the electrical components of the device.

3. The method of claim 2, wherein the battery charge current portion is greater than the additional load current portion.

4. The method of claim 1, wherein a duration of the current pulses is longer than an off time between the current pulses.

5. The method of claim 1, wherein a duration of the current pulses avoids detection by a charge sense circuit implemented by the device.

6. The method of claim 1, wherein the power source comprises an energy storage device housed by the charger and in electrical communication with the rechargeable battery when the charging circuitry is electrically connected to the rechargeable battery.

7. The method of claim 1, wherein the body-worn electronic device comprises a hearing aid device.

8. The method of claim 1, wherein the rechargeable battery comprises a rechargeable silver-zinc battery type.

9. The method of claim 1, wherein the rechargeable battery comprises a single cell or two or more cells in series, and wherein the charging circuitry is implemented upon a silicon chip.

10. The method of claim 1, wherein the predetermined voltage corresponds to one of a peak polarization voltage or a predetermined voltage value near the peak polarization voltage.

11. The method of claim 1, wherein the charging circuitry of the charger implements a microcontroller.

12. A wearable charging system comprising:
a first device housing a rechargeable battery configured to provide power to electrical components of the first device;
an energy storage device; and
a charger comprising charging circuitry configured to provide electrical communication between the energy storage device and the rechargeable battery when the charging circuitry is electrically connected to the rechargeable battery, the charging circuitry:
obtaining a voltage of the rechargeable battery prior to charging the rechargeable battery when the charging circuitry is electrically connected to the rechargeable battery;
comparing the rechargeable battery voltage to a voltage threshold;
when the rechargeable battery voltage is less than the voltage threshold, applying predetermined current pulses to the rechargeable battery with power provided from the energy storage device to simultaneously charge the rechargeable battery and power the electrical components of the first device;
starting a timer when the rechargeable battery voltage reaches a predetermined voltage greater than the voltage threshold; and
ceasing application of the predetermined current pulses to the rechargeable battery when the timer indicates that a predetermined time period has elapsed.

13. The system of claim 12, wherein the charger houses the energy storage device and is configured to attach to a user of the device.

14. The system of claim 12, further comprising:
a charging terminal configured to electrically connect with one or more charging elements of the first device, the charging elements in electrical communication with the rechargeable battery; and
one or more wires providing electrical communication between the charging circuitry and the charging terminal, the charging circuitry electrically connects to the rechargeable battery when the charging terminal is electrically connected with the one or more charging elements.

15. The system of claim 12, wherein the predetermined current pulses have an amplitude comprising a sum of a battery charge current portion to charge the rechargeable battery and an additional load current portion to compensate for a load upon the rechargeable battery for powering the electrical components of the first device.

16. The system of claim 15, wherein the battery charge current portion is greater than the additional load current portion.

17. The system of claim 12, wherein a duration of the current pulses is longer than an off time between the current pulses.

18. The system of claim 12, wherein a duration of the current pulses avoids detection by a charge sense circuit implemented by the first device.

19. The system of claim 12, wherein the first device comprises a hearing aid device worn by a user.

20. The system of claim 12, wherein the charging circuitry implements a microcontroller or is implemented upon a silicon chip.

21. The system of claim 12, wherein the energy storage device comprises one or more non-rechargeable alkaline batteries.
